(19) United States
(12) Patent Application Publication
(10) Pub. No.: US 2012/0299865 A1
(43) Pub. Date: Nov. 29, 2012

(54) Sensor for Capacitive Touch Panel Including Mesh Pattern and Capacitive Touch Panel Including the Same

(76) Inventor: Hyunseok Yu, Gyeonggi-do (KR)

(21) Appl. No.: 13/206,782

(22) Filed: Aug. 10, 2011

(30) Foreign Application Priority Data
May 25, 2011 (KR) 10-2011-0049604
Jul. 15, 2011 (KR) 10-2011-0070405

(51) Int. Cl. G06F 3/045

(52) U.S. Cl. 345/174

(57) ABSTRACT

A sensor for a capacitive touch panel including a mesh pattern and a capacitive touch panel including the same are disclosed. Each of a first electrode and a second electrode of a capacitor constituting of the capacitive touch panel includes a mesh pattern constituted by a honeycomb pattern.

### CROSS REFERENCE TO RELATED APPLICATIONS

This application claims foreign priority under 35 U.S.C. §119(a)-(d) to Korean Patent Application Nos. 10-2011-0049604 and 10-2011-0070405 filed on May 25, 2011 and Jul. 15, 2011, respectively, the entire contents of which are hereby incorporated by reference.

### FIELD OF THE INVENTION

The present invention relates to a sensor for a capacitive touch panel including a mesh pattern and a capacitive touch panel including the same, and more particularly to a sensor for a capacitive touch panel and a capacitive touch panel including the same comprising a mesh pattern consisting of a honeycomb pattern to improve a visibility.

### BACKGROUND

A touch panel is an apparatus attached to a front surface of a display panel such as an LCD panel to receive touch inputs from a user.

Generally, the touch panel is manufactured by forming an electrical conduction line on a surface of a transparent glass plate, and a position of the touch inputs from the user is detected via the electrical conduction line.

The touch panel is classified into a resistive touch panel which detects a change in an electrical current by a resistance and a capacitive touch panel which detects a change in capacitance.

Recently, as mobile devices are more equipped with the touch panels, the capacitive touch panel which has a better responsiveness than the resistive touch panel is gaining more popularity.

The capacitive touch panel is classified into a self capacitance touch panel and a mutual capacitance touch panel.

The mutual capacitance touch panel is more widely used recently since a multi-touch input is more easily embodied in the mutual capacitance touch panel than the self capacitance touch panel.

The mutual capacitance touch panel associated with the present invention is described in more detail below.

FIG. 1 is a plane view schematically exemplifying the mutual capacitance touch panel.

Referring to FIG. 1, the mutual capacitance touch panel comprises one or more sensors arranged at a constant distance. Each of one or more sensors comprises a capacitor, and is connected to a sensing circuit (not shown) which detects a change in the capacitance by a touch of a user.

An operation of the mutual capacitance touch panel will be described hereinafter with reference to FIG. 2.

FIG. 2a is a circuit diagram exemplifying the sensor and the sensing circuit, and FIGS. 2b and 2c are circuit diagrams exemplifying the sensor and the sensing circuit when the touch input of the user is applied.

Referring to FIG. 2a, each of one or more sensors comprises the capacitor consisting of a X-electrode and a Y-electrode, and is connected to the sensing circuit via Tx-line and Rx-line. The sensing circuit charges the capacitor with electrical charges and detects the change in the capacitance by the touch of the user.

Referring to FIGS. 2b and 2c, an amount of the electrical charges charged in the capacitor consisting of the X-electrode and the Y-electrode is changed when the touch input of the user is applied. That is, as shown in FIG. 2c, when the touch input is applied to the sensing circuit, the capacitor consisting of the Y-electrode and a Z-electrode is formed by as a human body serves as a capacitor electrode. The amount of the electrical charges charged in the capacitor consisting of the X-electrode and the Y-electrode decreased due to the capacitor consisting of the Y-electrode and a Z-electrode, which is sensed by the sensing circuit thereby detecting the touch input of the user.

The capacitor consisting of the X-electrode and the Y-electrode may be embodied by a SITO (Single Indium Tin Oxide) structure or a DITO (Double Indium Tin Oxide) structure.

FIGS. 3a and 3b are cross-sectional views schematically illustrating the SITO structure and the DITO structure, respectively.

Referring to FIG. 3a, in the SITO structure, the X-electrode and the Y-electrode are disposed to be substantially coplanar. The SITO structure provides thinner sensors compared to the DITO structure.

Referring to FIG. 3b, in the DITO structure, the X-electrode and the Y-electrode are vertically disposed. The DITO structure is more robust to noise compared to the SITO structure.

The X-electrode and the Y-electrode are made of an ITO (Indium Tin Oxide) which is a solid solution of In₂O₃ and SnO₂. The ITO is a transparent conductive oxide, which makes it suitable for the touch panel. However, since a RC time constant of the ITO is too large, a sensitivity of the touch panel is degraded.

The RC time constant may be reduced by using a metal material instead of the ITO. However, when the capacitor is manufactured using the X-electrode and the Y-electrode shown in FIG. 4, a visibility of the touch panel is degraded due to an opacity of the metal material. In addition, when a line width of the X-electrode and the Y-electrode is reduced in order to improve the visibility, an amount of the capacitance required for detecting the touch input of the user may be not obtained.

In order to above-described problems, an X-electrode and a Y-electrode shown in FIG. 5b using a mesh pattern shown in FIG. 5a has been proposed.

A capacitor consisting of the X-electrode and the Y-electrode shown in FIG. 5b is superior to the capacitor consisting of X-electrode and the Y-electrode shown in FIG. 4 in the visibility. However, the mesh pattern as shown in FIG. 5a may cause a diffraction, a refraction, a diffused reflection of light and a moiré phenomenon resulting in a change in the visibility according to a viewing angle.

### SUMMARY

It is an object of the present invention to provide a sensor for a capacitive touch panel including a mesh pattern and a capacitive touch panel including the same comprising a mesh pattern consisting of a honeycomb pattern to improve a visibility.

In order to achieve above-described object of the present invention, there is provided a sensor for a capacitive touch panel comprising: a first electrode; and a second electrode forming a capacitor with the first electrode, and wherein each of the first electrode and the second electrode comprises a mesh pattern, the mesh pattern including a honeycomb pattern; and a diamond pattern overlapped with and electrically connected to the honeycomb pattern.

Preferably, the first electrode and the second electrode are disposed to be substantially coplanar.

Preferably, the honeycomb pattern comprises one or more hexagons made of a metal wire.

Preferably, the diamond pattern comprises one or more tetragons made of the metal wire.

Preferably, each side of each of the one or more tetragons comprises a wave-shaped metal wire.

Preferably, the diamond pattern is overlapped with the honeycomb pattern in a manner that a center of each of the one or more hexagons is aligned to each of vertices of each of the one or more tetragons.

Preferably, a diameter of the metal wire ranges from 2 to 30 μm.

Preferably, the diameter of the metal wire ranges from 5 to 7 μm.

Preferably, the metal wire comprises one of silver and copper.

The sensor in accordance with the present invention may further comprise a PET film disposed between the first electrode and the second electrode.

There is also provided a capacitive touch panel comprising: a dummy film; a sensor layer disposed on the dummy film; and an insulation layer disposed on the sensor layer, wherein the sensor layer comprises a sensor including a first electrode; and a second electrode forming a capacitor with the first electrode, and wherein each of the first electrode and the second electrode comprises a mesh pattern, the mesh pattern including a honeycomb pattern; and a diamond pattern overlapped with and electrically connected to the honeycomb pattern.

Preferably, the first electrode and the second electrode are disposed to be substantially coplanar.

Preferably, the honeycomb pattern comprises one or more hexagons made of a metal wire.

Preferably, the diamond pattern comprises one or more tetragons made of the metal wire.

Preferably, each side of each of the one or more tetragons comprises a wave-shaped metal wire.

Preferably, the diamond pattern is overlapped with the honeycomb pattern in a manner that a center of each of the one or more hexagons is aligned to each of vertices of each of the one or more tetragons.

Preferably, the metal wire comprises one of silver and copper.

The capacitive touch panel in accordance with the present invention may further comprise a PET film disposed between the first electrode and the second electrode.

Preferably, the dummy film comprises one of a PET film and an anti-reflection film.

There is also provided a sensor for a capacitive touch panel comprising: a first electrode; and a second electrode forming a capacitor with the first electrode, and wherein each of the first electrode and the second electrode comprises a mesh pattern including one or more unit patterns, and each of the one or more unit patterns comprises a hexagonal metal wire pattern including at least a first side, a third side, a fourth side facing the first side and a sixth side facing the third side; and a X-shaped metal wire pattern including a first metal wire connected to the first side and the fourth side and a second metal wire connected to the third side and the sixth side.

There is also provided a sensor for a capacitive touch panel comprising: a first electrode; and a second electrode forming a capacitor with the first electrode, and wherein each of the first electrode and the second electrode comprises a mesh pattern, the mesh pattern including a first honeycomb pattern; and a second honeycomb pattern electrically connected to and overlapping with the first honeycomb pattern in a manner that the second honeycomb pattern is misaligned to the first honeycomb pattern.

There is also provided a capacitive touch panel comprising: a dummy film; a sensor layer disposed on the dummy film; and an insulation layer disposed on the sensor layer, wherein the sensor layer comprises a sensor including a first electrode; and a second electrode forming a capacitor with the first electrode, and wherein each of the first electrode and the second electrode comprises a mesh pattern, the mesh pattern including a first honeycomb pattern; and a second honeycomb pattern electrically connected to the first honeycomb pattern and overlapped therewith in a manner that the second honeycomb pattern is misaligned to the first honeycomb pattern.

There is also provided a sensor for a capacitive touch panel comprising: a first electrode; and a second electrode forming a capacitor with the first electrode, and wherein each of the first electrode and the second electrode comprises a mesh pattern including one or more unit patterns, and each of the one or more unit patterns comprises a second pentagonal pattern and a fourth pentagonal pattern arranged to have a common side; a first pentagonal pattern arranged to have a commons side with each of the second pentagonal pattern and the fourth pentagonal pattern; and a third pentagonal pattern arranged to have a common side with each of the second pentagonal pattern and the fourth pentagonal pattern.

Preferably, the first electrode and the second electrode are disposed to be substantially coplanar.

Preferably, each of the first honeycomb pattern and the second honeycomb pattern comprises one or more hexagonal patterns made of a metal wire.

Preferably, the one or more hexagonal patterns are consecutively arranged in vertical and horizontal directions.

Preferably, each side of each of the one or more hexagonal patterns comprises a wave-shaped metal wire.

Preferably, the first honeycomb pattern overlaps with the second honeycomb pattern in a manner that a common side of two of the one or more hexagonal patterns included in the first honeycomb pattern neighboring in a horizontal direction is arranged within one of the one or more hexagonal patterns included in the second honeycomb pattern.

Preferably, a diameter of the metal wire ranges from 2 to 30 μm.

Preferably, the diameter of the metal wire ranges from 5 to 7 μm.

Preferably, the metal wire comprises one of silver and copper.

The capacitive touch panel in accordance with the present invention may further comprise a PET film disposed between the first electrode and the second electrode.

Preferably, the dummy film comprises one of a PET film and an anti-reflection film.

### BRIEF DESCRIPTION OF THE DRAWINGS

FIG. 1 is a plane view schematically exemplifying a mutual capacitance touch panel.

FIGS. 2a through 2c are circuit diagrams exemplifying a sensor and a sensing circuit.

FIGS. 3a and 3b are cross-sectional views schematically illustrating a SITO structure and a DITO structure, respectively.

FIG. 4 is a plane view exemplifying an embodiment of an X-electrode and a Y-electrode.

FIGS. 5a and 5b are plane views exemplifying a conventional mesh pattern and an X-electrode and a Y-electrode including a mesh pattern shown in FIG. 5a, respectively.

FIGS. 6a and 6b are plane views exemplifying a mesh pattern in accordance with a first embodiment of the present invention.

FIG. 7 is a plane view exemplifying a unit pattern of a mesh pattern 600 in accordance with the first embodiment of the present invention.

FIGS. 8a through 8d are plane views exemplifying a mesh pattern in accordance with a second embodiment of the present invention.

FIG. 9 is a plane view exemplifying a unit pattern of a mesh pattern 600 in accordance with the second embodiment of the present invention.

FIGS. 10a and 10b are plane views illustrating an embodiment of a first electrode and a second electrode in accordance with the first embodiment and the second embodiment of the present invention, respectively.

FIG. 11 illustrates cross-sections of the first electrode and the second electrode shown in FIGS. 10a and 10b in accordance with the present invention.

FIG. 12 is a cross-sectional view exemplifying a capacitive touch panel in accordance with the present invention.

FIG. 13 is a cross-sectional view exemplifying a sensor layer of the capacitive touch panel in accordance with the present invention.

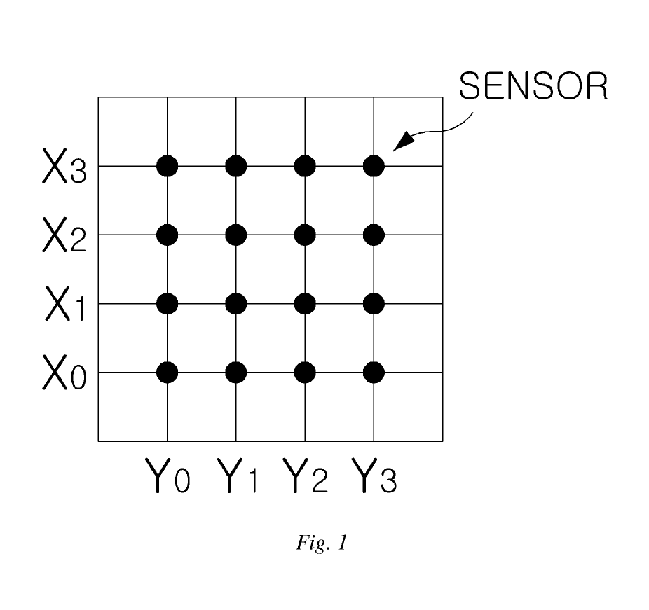

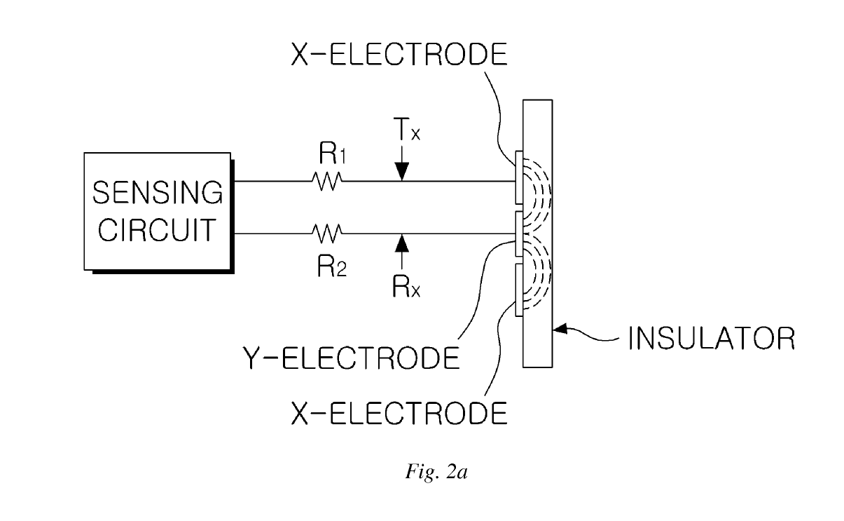

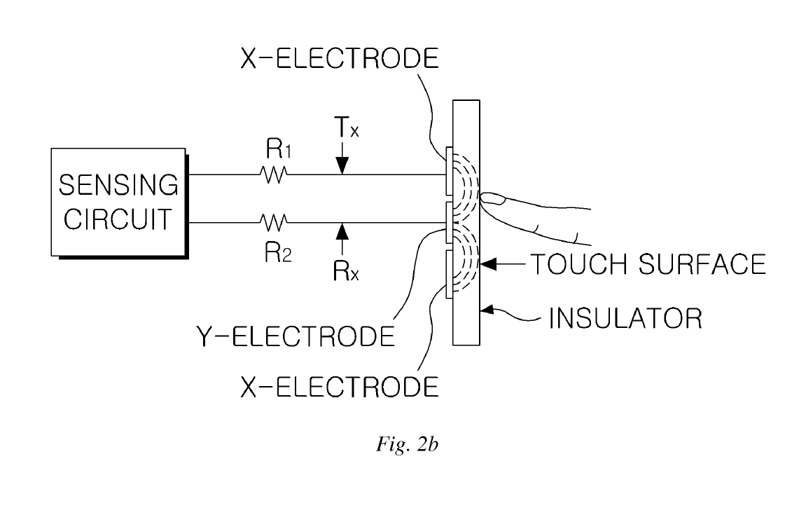

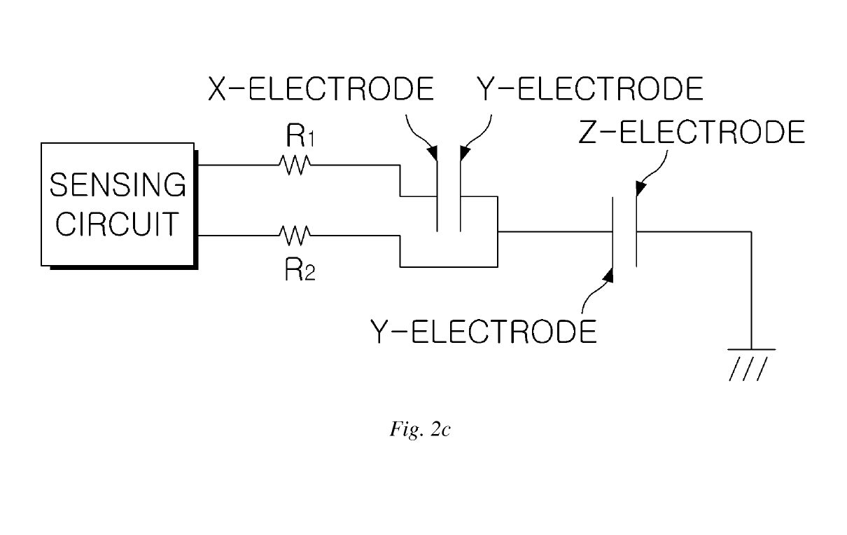

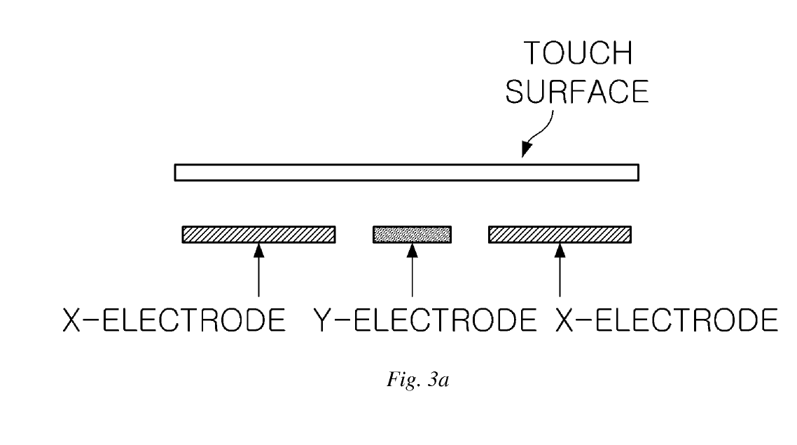

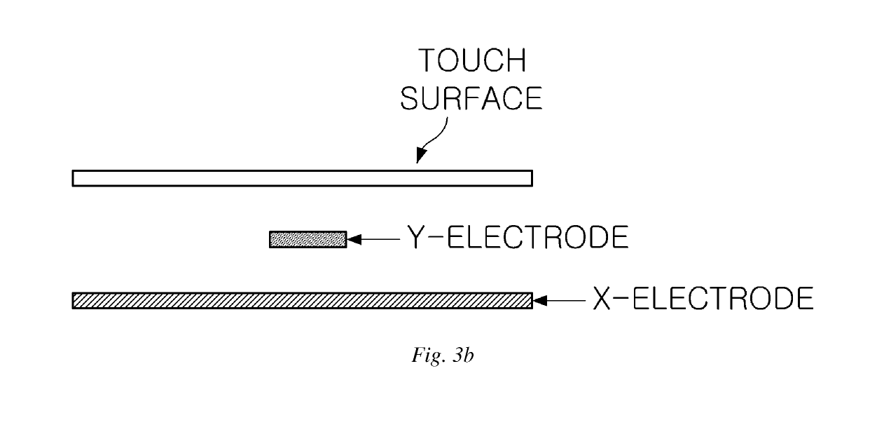

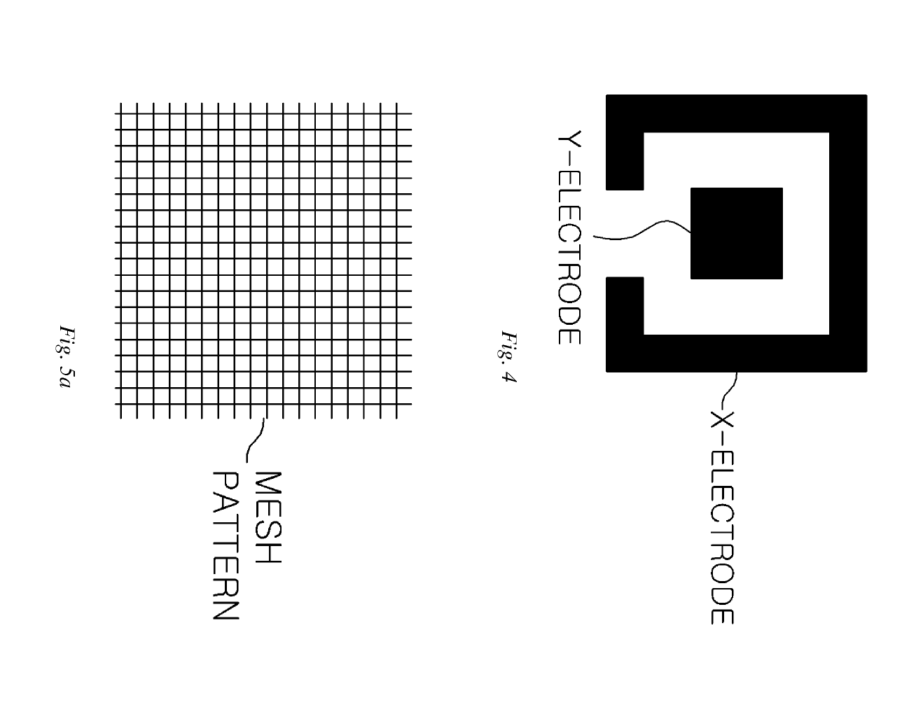

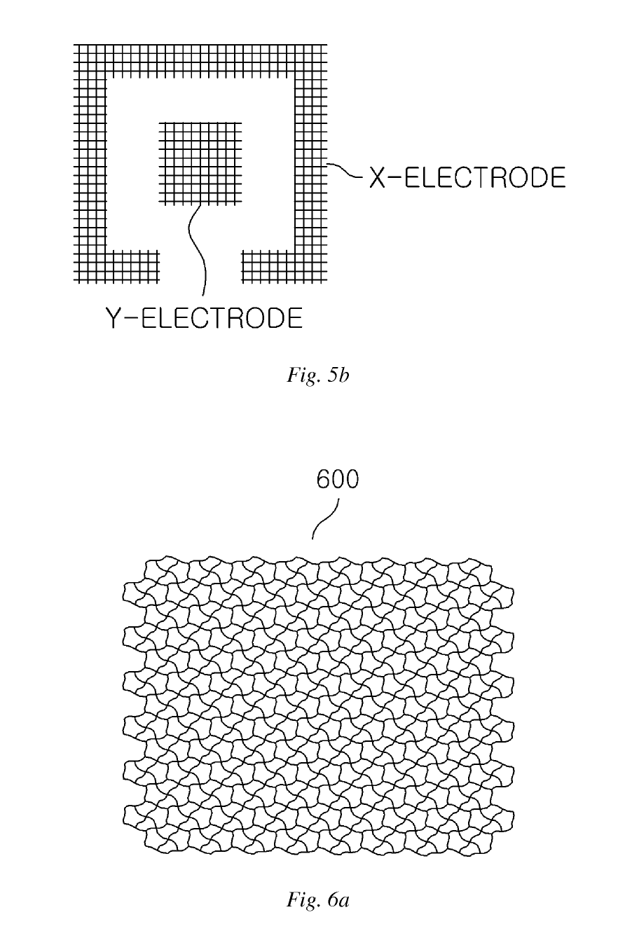

### DETAILED DESCRIPTION

A sensor for a capacitive touch panel including a mesh pattern and a capacitive touch panel including the same in accordance with the present invention will be described in detail with reference to accompanied drawings.

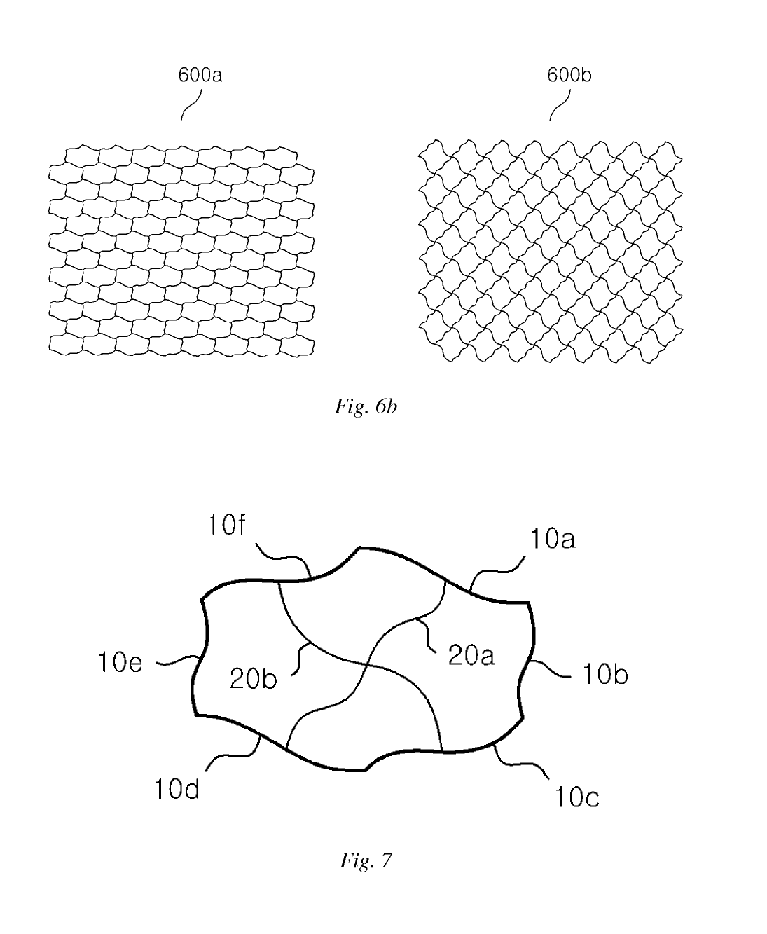

FIG. 6a is a plane view exemplifying a mesh pattern in accordance with a first embodiment of the present invention, and FIG. 6b is a plane view exemplifying the mesh pattern in accordance with the first embodiment of the present invention wherein the mesh pattern is divided into a honeycomb pattern and a diamond pattern.

Referring to FIGS. 6a and 6b, a mesh pattern 600 includes a honeycomb pattern 600a and a diamond pattern 600b. The honeycomb pattern 600a comprises one or more hexagons made of a metal wire. The diamond pattern 600b overlaps with and is electrically connected to the honeycomb pattern 600a. The diamond pattern 600b comprises one or more tetragons made of the metal wire. Each side of each of the one or more tetragons constituting of the diamond pattern 600b comprises a wave-shaped metal wire.

Preferably, a diameter of the metal wire constituting the honeycomb pattern 600a and the diamond pattern 600b ranges from 2 to 30 μm. More preferably, in order to improve a visibility, the diameter of the metal wire ranges from 5 to 7 μm.

The metal wire may comprise one of silver and copper. Preferably, a surface of the metal wire is melanized.

As shown in FIG. 6a, the honeycomb pattern 600a overlaps with (overlays) the diamond pattern 600b in a manner that a center of the hexagon is aligned to each vertex of the tetragon. Although FIG. 6b depicts the honeycomb pattern 600a and the diamond pattern 600b separated from each other, it is preferable that the honeycomb pattern 600a and the diamond pattern 600b are of a single body.

The mesh pattern 600 in accordance with the first embodiment of the present invention may be formed using a printing method or a photolithography method.

FIG. 7 is a plane view exemplifying a unit pattern of a mesh pattern 600 in accordance with the first embodiment of the present invention. While the mesh pattern 600 may be divided into the honeycomb pattern 600a and the diamond pattern 600b as shown in FIGS. 6a and 6b, the mesh pattern 600 may be divided into the unit patterns as shown in FIG. 7.

Referring to FIG. 7, the mesh pattern 600 comprises one or more unit patterns 60 that are consecutively arranged in vertical and horizontal directions. Each of the unit patterns 60 comprises a hexagonal metal wire pattern which includes a first side 10a through a sixth side 10f and a X-shaped metal wire pattern which includes a first metal wire 20a and a second metal wire 20b. A fourth side 10d of the hexagonal metal wire pattern faces the first side 10a, and the third side 10c faces the sixth side 10f. The first metal wire 20a is connected to the first side 10a and the fourth side 10d, and the second metal wire 20b is connected to the third side 10c and the sixth side 10f.

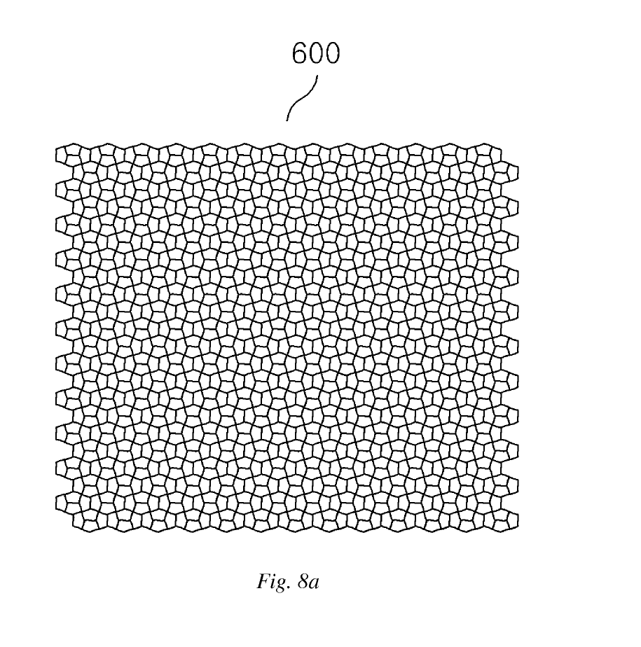

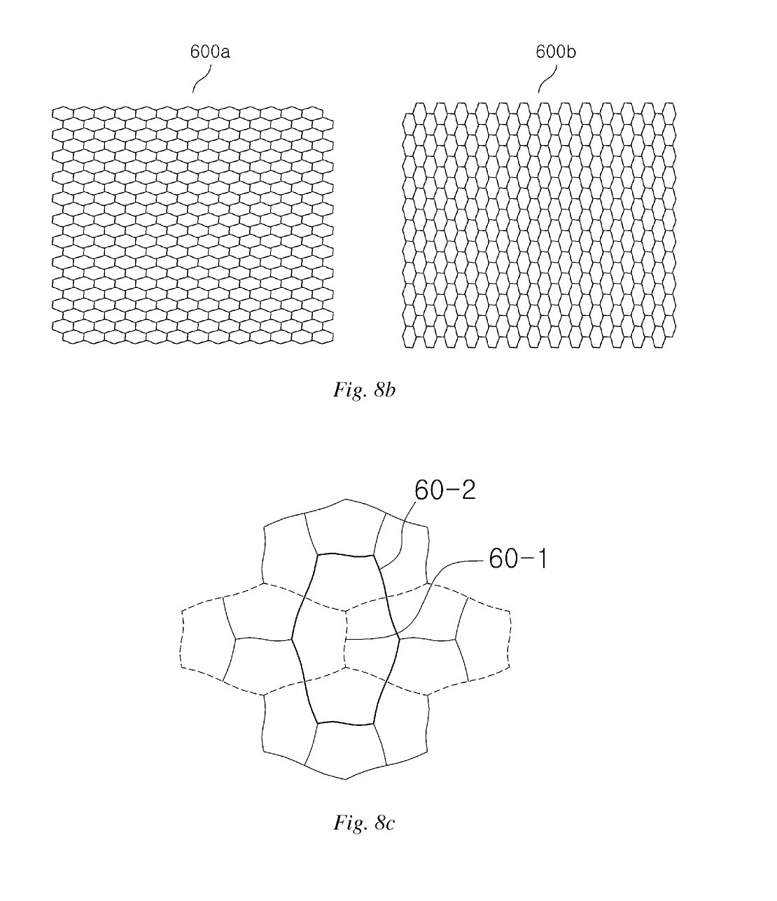

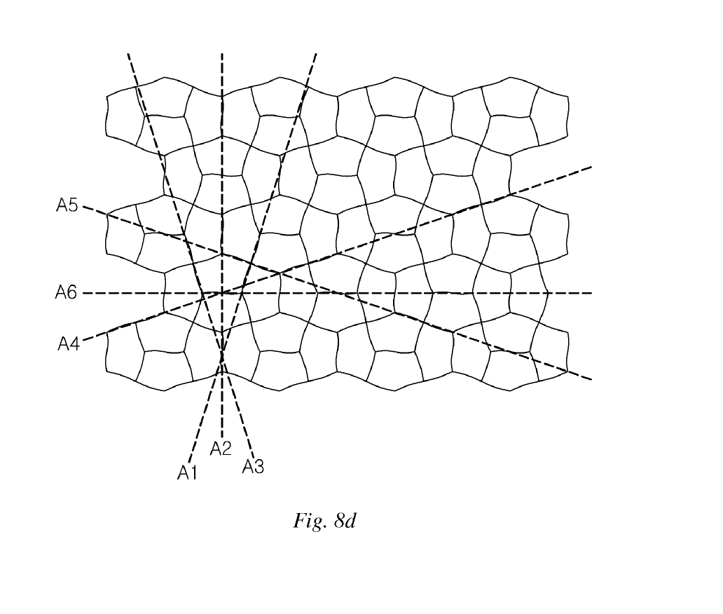

FIG. 8a is a plane view exemplifying a mesh pattern in accordance with a second embodiment of the present invention, FIG. 8b is a plane view exemplifying the mesh pattern in accordance with the second embodiment of the present invention wherein the mesh pattern is divided into a first honeycomb pattern 600a and a second honeycomb pattern 600b, FIG. 8c is an enlarged plane view exemplifying the mesh pattern in accordance with the second embodiment of the present invention, and FIG. 8d is a plane view exemplifying angles in the mesh pattern in accordance with the second embodiment of the present invention.

Referring to FIGS. 8a through 8d, the mesh pattern 600 includes the first honeycomb pattern 600a and the second honeycomb pattern 600b. The first honeycomb pattern 600a comprises one or more hexagonal patterns made of a metal wire. The one or more hexagonal patterns are consecutively arranged in vertical and horizontal directions. The second honeycomb pattern 600b is electrically connected to and is overlapped with the first honeycomb pattern 600a. The second honeycomb pattern 600b is misaligned to the first honeycomb pattern 600a. The second honeycomb pattern 600b comprises one or more hexagonal patterns made of the metal wire, and the one or more hexagonal patterns are consecutively arranged in vertical and horizontal directions.

The misalignment of the first honeycomb pattern 600a and 600b means that each of the one or more hexagonal patterns included in the first honeycomb pattern 600a is overlapped with but is misaligned to each of the one of the one or more hexagonal patterns included in the second honeycomb pattern 600b. That is, each side of the hexagonal pattern included in the first honeycomb pattern 600a does not overlap, in an aligned manner, each side of the hexagonal pattern included in the second honeycomb pattern 600b, and each side of the hexagonal pattern included in the first honeycomb pattern 600a and each side of the hexagonal pattern included in the second honeycomb pattern 600b cross each other.

Each side of each of one or more hexagonal patterns included in the first honeycomb pattern 600a and each side of each of one or more hexagonal patterns include in the second honeycomb pattern 600b comprise wave-shaped metal wires, respectively.

Preferably, a diameter of the metal wire constituting the first honeycomb pattern 600a and the second honeycomb pattern 600b ranges from 2 to 30 μm. More preferably, in order to improve a visibility, the diameter of the metal wire ranges from 5 to 7 μm.

The metal wire may comprise one of silver and copper. Preferably, a surface of the metal wire is melanized.

As shown in FIG. 8c, the first honeycomb pattern 600a overlaps with the second honeycomb pattern 600b in a manner that a common side 60-1 of two of the one or more hexagonal patterns (shown in FIG. 8c in dotted line) included in the first honeycomb pattern 600a neighboring in a horizontal direction is arranged within one of the one or more hexagonal patterns 60-2 (shown in FIG. 8c in bold line) included in the second honeycomb pattern 600b.

Although FIG. 8b depicts the first honeycomb pattern 600a and the second honeycomb pattern 600b separated from each other, the first honeycomb pattern 600a and the second honeycomb pattern 600b are of a single body.

Referring to FIG. 8d, six different angles A₁ through A₆ present in the mesh pattern 600 constituted by the first honeycomb pattern 600a and the second honeycomb pattern 600b. As the number of the angles present in the mesh pattern 600 increases, a moiré phenomenon decreases. For instance, since five different angles are present in the mesh pattern 600 including the honeycomb pattern 600a and the diamond pattern 600b in accordance with the first embodiment of the present invention, more moiré phenomenon occurs in the mesh pattern 600 in accordance with the first embodiment of the present invention compared to the mesh pattern 600 in accordance with the second embodiment of the present invention. Therefore, the mesh pattern 600 in accordance with the second embodiment of the present invention may suppress the moiré phenomenon more than the mesh pattern 600 in accordance with the present invention. The mesh pattern 600 in accordance with the second embodiment of the present invention may be formed using a printing method or a photolithography method.

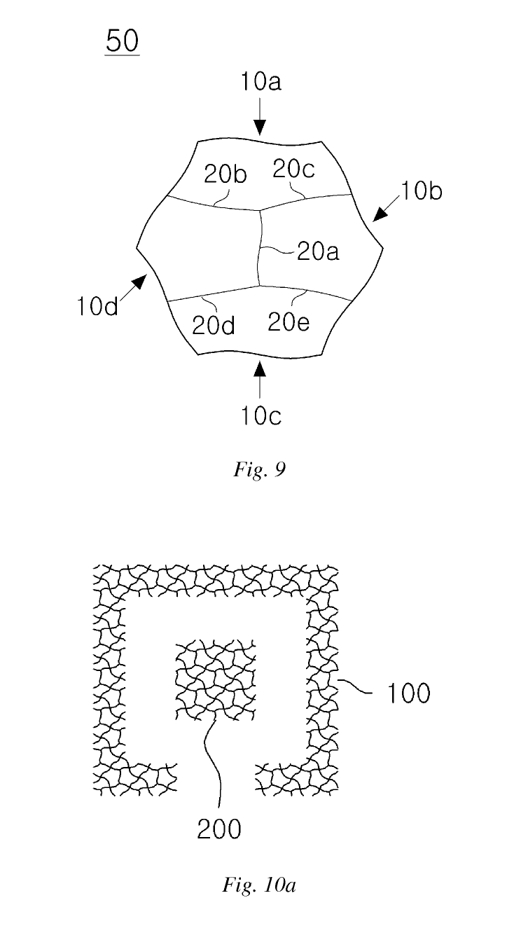

FIG. 9 is a plane view exemplifying a unit pattern of a mesh pattern 600 in accordance with the second embodiment of the present invention. While the mesh pattern 600 may be divided into the first honeycomb pattern 600a and the second honeycomb pattern 600b as shown in FIGS. 8a and 8b, the mesh pattern 600 may be divided into the unit pattern 50 as shown in FIG. 9.

Referring to FIG. 9, the mesh pattern 600 comprises one or more unit patterns 50 that are consecutively arranged in vertical and horizontal directions. Each of the unit patterns 50 comprises a first pentagonal pattern 10a through a fourth pentagonal pattern 10d. As shown in FIG. 9, a second pentagonal pattern 10b and the fourth pentagonal pattern 10d are arranged to have a common side 20a. In addition, the first pentagonal pattern 10a is arranged to have common sides 20c and 20b with the second pentagonal pattern 10b and the fourth pentagonal pattern 10d, respectively, and a third pentagonal pattern 10c is arranged to have common sides 20e and 20d with the second pentagonal pattern 10b and the fourth pentagonal pattern 10d, respectively.

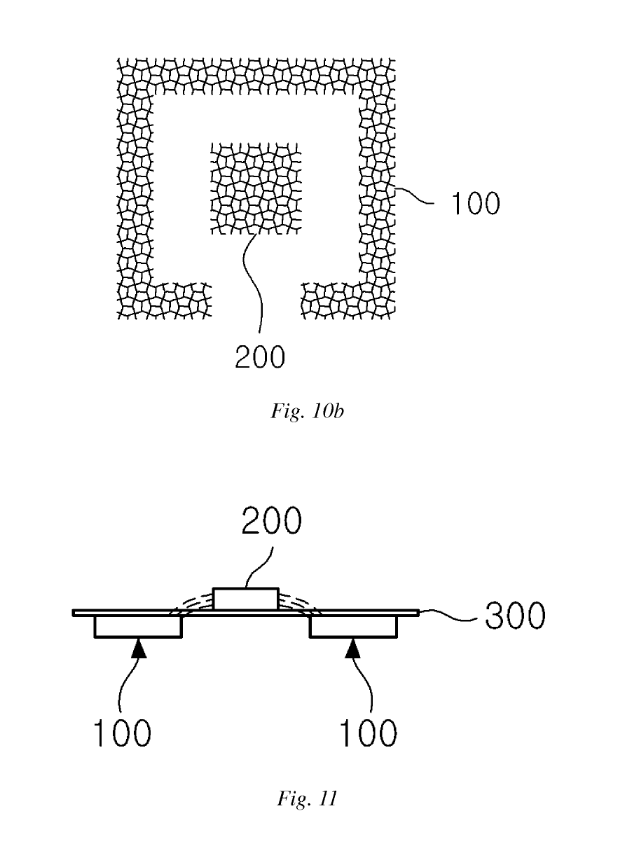

FIGS. 10a and 10b are plane views illustrating an embodiment of a first electrode and a second electrode in accordance with the first embodiment and the second embodiment of the present invention, respectively, and FIG. 11 illustrates cross-sections of the first electrode and the second electrode shown in FIGS. 10a and 10b in accordance with the present invention.

Referring to FIGS. 10 and 11, each of the first electrode 100 and the second electrode 200 are formed by patterning the mesh pattern 600 into a predetermined shape. While FIGS. 10a and 10b exemplify capacitors constituted by the first electrode 100 and the second electrode 200 formed by the mesh pattern 600 in accordance with the first embodiment and the second embodiment of the present invention, respectively, the shapes of the first electrode 100 and the second electrode 200 are not limited to the shapes shown in FIGS. 10a and 10b, and may have different shapes.

The first electrode 100 forms the capacitor, i.e., a sensor, with the second electrode 200, and the sensor is disposed on every node of the capacitive touch panel in accordance with the present invention.

The first electrode 100 and the second electrode 200 may be disposed in substantially coplanar manner, and a PET (PolyEthylene Terephthalate) may be disposed between the first electrode 100 and the second electrode 200 for insulation.

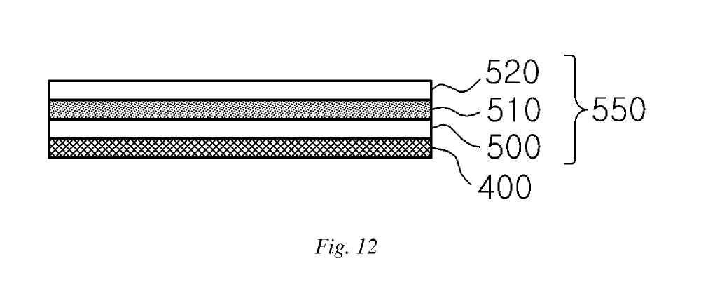

FIG. 12 is a cross-sectional view exemplifying the capacitive touch panel in accordance with the present invention.

Referring to FIG. 12, the capacitive touch panel 550 in accordance with the present invention comprises a dummy film 500, a sensor layer 510 disposed on the dummy film 500 and an insulation layer 520 disposed on the sensor layer 510.

The dummy film 500 may comprise one of the PET film 300 and an anti-reflection film. In addition, the dummy film 500 reduces a phenomenon wherein a sensor pattern is visible to the naked eye of an user and a cross-filter effect by decreasing a diffraction, a diffused reflection and a refraction of a light generated by an air gap between the capacitive touch panel 550 and a display panel 400.

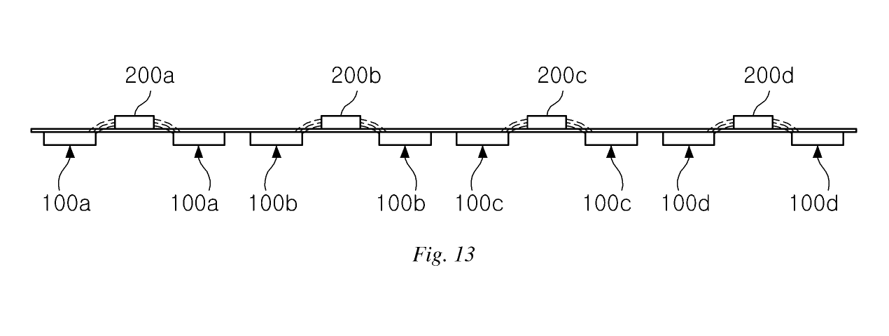

FIG. 13 is a cross-sectional view exemplifying the sensor layer of the capacitive touch panel in accordance with the present invention.

As shown in FIG. 13, the sensor layer 510 comprises the capacitors, i.e., the sensors, described with reference to FIGS. 6 through 11. The sensors comprise the first electrode 100a through 100d and the second electrode 200a through 200d. Because the sensors are described in detail with reference to FIGS. 6 through 11, the detailed description of the sensors in the sensor layer 510 is omitted.

A sensor for a capacitive touch panel including a mesh pattern and a capacitive touch panel including the same in accordance with the present invention have following advantages.

Since the sensor and the capacitive touch panel in accordance with the present invention include electrodes of the mesh pattern made of the metal wire, the sensor and the capacitive touch panel have a superior conductivity and a small RC time constant.

In addition, since the mesh pattern in accordance with the present invention may be manufactured using a metal having a low resistance via the printing method or the photolithography method, manufacturing cost of the mesh pattern may be reduced.

The dummy film included in the capacitive touch panel in accordance with the present invention provides a superior visibility by decreasing the diffraction, the diffused reflection and the refraction of the light.

While the present invention has been particularly shown and described with reference to the preferred embodiment thereof, it will be understood by those skilled in the art that various changes in form and details may be effected therein without departing from the spirit and scope of the invention as defined by the appended claims.

What is claimed is:

1. A sensor for a capacitive touch panel comprising:
a first electrode; and
a second electrode forming a capacitor with the first electrode,
wherein each of the first electrode and the second electrode comprises a mesh pattern, the mesh pattern including a honeycomb pattern; and a diamond pattern overlapping with and electrically connected to the honeycomb pattern.

2. The sensor in accordance with claim 1, wherein the first electrode and the second electrode are disposed to be substantially coplanar.

3. The sensor in accordance with claim 1, wherein the honeycomb pattern comprises one or more hexagons made of a metal wire.

4. The sensor in accordance with claim 3, wherein the diamond pattern comprises one or more tetragons made of the metal wire.

5. The sensor in accordance with claim 4, wherein each side of each of the one or more tetragons comprises a wave-shaped metal wire.

6. The sensor in accordance with claim 4, wherein the diamond pattern overlaps with the honeycomb pattern in a manner that a center of each of the one or more hexagons is aligned to each of vertices of each of the one or more tetragons.

7. The sensor in accordance with claim 4, wherein a diameter of the metal wire ranges from 2 to 30 μm.

8. The sensor in accordance with claim 7, wherein the diameter of the metal wire ranges from 5 to 7 μm.

9. The sensor in accordance with claim 4, wherein the metal wire comprises one of silver and copper.

10. The sensor in accordance with claim 1, further comprising a PET film disposed between the first electrode and the second electrode.

11. A capacitive touch panel comprising:
a dummy film;
a sensor layer disposed on the dummy film; and
an insulation layer disposed on the sensor layer,
wherein the sensor layer comprises a sensor including a first electrode; and a second electrode forming a capacitor with the first electrode, and wherein each of the first electrode and the second electrode comprises a mesh pattern, the mesh pattern including a honeycomb pattern; and a diamond pattern overlapping with and electrically connected to the honeycomb pattern.

12. The capacitive touch panel in accordance with claim 11, wherein the dummy film comprises one of a PET film and an anti-reflection film.

13. A sensor for a capacitive touch panel comprising:
a first electrode; and
a second electrode forming a capacitor with the first electrode,
wherein each of the first electrode and the second electrode comprises a mesh pattern including one or more unit patterns, and each of the one or more unit patterns comprises a hexagonal metal wire pattern including at least a first side, a third side, a fourth side facing the first side and a sixth side facing the third side; and a X-shaped metal wire pattern including a first metal wire connected to the first side and the fourth side and a second metal wire connected to the third side and the sixth side.

14. A sensor for a capacitive touch panel comprising:
a first electrode; and
a second electrode forming a capacitor with the first electrode,
wherein each of the first electrode and the second electrode comprises a mesh pattern, the mesh pattern including a first honeycomb pattern; and a second honeycomb pattern electrically connected to and overlapping with the first honeycomb pattern in a manner that the second honeycomb pattern is misaligned to the first honeycomb pattern.

15. The sensor in accordance with claim 14, wherein the first electrode and the second electrode are disposed to be substantially coplanar.

16. The sensor in accordance with claim 14, wherein each of the first honeycomb pattern and the second honeycomb pattern comprises one or more hexagonal patterns made of a metal wire.

17. The sensor in accordance with claim 16, wherein the one or more hexagonal patterns are consecutively arranged in vertical and horizontal directions.

18. The sensor in accordance with claim 16, wherein each side of each of the one or more hexagonal patterns comprises a wave-shaped metal wire.

19. The sensor in accordance with claim 16, wherein the first honeycomb pattern overlaps with the second honeycomb pattern in a manner that a common side of two of the one or more hexagonal patterns included in the first honeycomb pattern neighboring in a horizontal direction is arranged within one of the one or more hexagonal patterns included in the second honeycomb pattern.

20. The sensor in accordance with claim 16, wherein a diameter of the metal wire ranges from 2 to 30 μm.

21. The sensor in accordance with claim 20, wherein the diameter of the metal wire ranges from 5 to 7 μm.

22. The sensor in accordance with claim 16, wherein the metal wire comprises one of silver and copper.

23. The sensor in accordance with claim 14, further comprising a PET film disposed between the first electrode and the second electrode.

24. A capacitive touch panel comprising:
a dummy film;
a sensor layer disposed on the dummy film; and
an insulation layer disposed on the sensor layer,
wherein the sensor layer comprises a sensor including a first electrode; and a second electrode forming a capacitor with the first electrode, and wherein each of the first electrode and the second electrode comprises a mesh pattern, the mesh pattern including a first honeycomb pattern; and a second honeycomb pattern electrically connected to the first honeycomb pattern and overlapped therewith in a manner that the second honeycomb pattern is misaligned to the first honeycomb pattern.

25. The capacitive touch panel in accordance with claim 24, the dummy film comprises one of a PET film and an anti-reflection film.

26. A sensor for a capacitive touch panel comprising:
a first electrode; and
a second electrode forming a capacitor with the first electrode,
wherein each of the first electrode and the second electrode comprises a mesh pattern including one or more unit patterns, and each of the one or more unit patterns comprises a second pentagonal pattern and a fourth pentagonal pattern arranged to have a common side; a first pentagonal pattern arranged to have a commons side with each of the second pentagonal pattern and the fourth pentagonal pattern; and a third pentagonal pattern arranged to have a common side with each of the second pentagonal pattern and the fourth pentagonal pattern.
